(19) United States
(12) Patent Application Publication
(10) Pub. No.: US 2019/0360238 A1
(43) Pub. Date: Nov. 28, 2019

(54) ANTI-THEFT STRUCTURE OF DUAL-LOCKING LOCK

(71) Applicants: Wen-Kuei Liu, Taichung City (TW); Chao-Hsuan Liu, Taichung City (TW); Yu-Chun Liu, Taichung City (TW); Yi-Shan Liu, Taichung City (TW)

(72) Inventors: Wen-Kuei Liu, Taichung City (TW); Chao-Hsuan Liu, Taichung City (TW); Yu-Chun Liu, Taichung City (TW); Yi-Shan Liu, Taichung City (TW)

(21) Appl. No.: 15/987,501

(22) Filed: May 23, 2018

(51) Int. Cl. E05B 17/14; E05B 19/00; G07C 9/00

(52) U.S. Cl. CPC E05B 17/142; G07C 9/00563; E05B 19/0047

(57) ABSTRACT

An anti-theft structure of a dual-locking lock includes a lock body, an electronic lock, a key lock and a key. The electronic lock is disposed on the lock body. The key lock includes a lock head and a plug cap. The lock head is combined with the lock body and has a front side surface with a key hole. The plug cap covers over the front side surface of the lock head, and has an inner portion with a chamber, and a circumferential surface provided with a window communicating with the chamber. The key includes a head and an extension arm perpendicularly extending from one side of the head. The head can be put into the chamber from the window and then inserted into the key hole and then rotated by an angle to perform unlocking or locking. With the above-mentioned structure, the good anti-theft effect is obtained.

### BACKGROUND OF THE INVENTION

### 1. Field of the Invention

The invention relates to the technical field of a structure of a dual-locking lock, and more particularly to an anti-theft structure of a dual-locking lock, which can prevent a key hole from being directly and obviously exposed to the outside, so that a thief cannot directly see the inner portion through the key hole and cannot easily insert an unlock tool to perform unlocking, and that the good anti-theft effect is obtained.

### 2. Description of the Prior Art

At present, in order to increase the convenience, security and ease of management of unlocking and locking in the conventional locks common in the market, intelligent or smart electronic locks installed with fingerprint identification, iris recognition, face recognition, voice recognition, password input, sensor input, card input or the like tend to be developed. However, because the electronic lock needs electric power and its inner components are precise, the electronic lock cannot be unlocked when the power is off, malfunction occurs or other factors occur. So, a mechanical emergency lock (i.e., key lock) is usually additionally provided on the lock to form a dual-locking lock. Generally, an insert port of a key hole of a key lock of the conventional dual-locking lock is designed to face frontward, so the thief can easily and directly see inner structures, such as locking beads, in the key hole, and the unlock tool also can be inserted into the key hole to perform unlocking according to the mind of the thief. So, although the electronic lock with the dual-locking lock has the good anti-unlocking technology and becomes securer, the emergency key lock also has the security flaw.

In view of this, the present inventor has made deep conceiving, active research, improvements and tries to solve the above-mentioned problems, and thus developed and designed the present invention.

### SUMMARY OF THE INVENTION

A main objective of the invention is to solve the problem of the poor anti-theft effect present in the conventional dual-locking lock.

An anti-theft structure of a dual-locking lock of the invention includes a lock body, an electronic lock, a key lock and a key. The electronic lock is disposed on the lock body and is to be locked and unlocked by a user. The key lock includes a lock head and a plug cap, the lock head is combined with the lock body, a front side surface of the lock head has a key hole, and an inner portion of the plug cap has a chamber with an opening facing a side surface, wherein the opening of the plug cap covers over the front side surface of the lock head, and a circumferential surface of the plug cap is provided with a window communicating with the chamber. The key includes a head and an extension arm perpendicularly extending from one side of the head, so that the head can be put into the chamber from the window of the plug cap and then inserted into the key hole and then rotated by an angle to perform unlocking or locking.

In the anti-theft structure of the dual-locking lock provided by the invention, the plug cap can cover over the front side of the lock head to prevent the key hole of the lock head from being directly and obviously exposed to the outside, so that the thief cannot directly see internal structures of the lock head through the key hole. Moreover, the window formed on the circumferential surface of the plug cap can be used to unlock and lock the key of the special structure of the invention, and also prevent the common unlocking tools available in the market from being inserted into the key hole for unlocking. Therefore, it has a good anti-theft effect and can avoid the security flaw of the dual-locking lock.

### BRIEF DESCRIPTION OF THE DRAWINGS

FIG. 1 is a pictorially schematic decomposed view showing the invention.

FIG. 2 is a pictorially decomposed enlarged schematic view showing a key lock of the invention.

FIG. 3 is a pictorially schematic assembled view showing the invention.

FIG. 4 is a schematic view showing an operation of the key inserting into the plug cap according to the invention.

FIG. 5 is a schematic view showing an operation of the key inserting into the key hole according to the invention.

FIG. 6 is a schematic view showing an operation of the key rotating by an angle to perform unlocking according to the invention.

### DETAILED DESCRIPTION OF THE PREFERRED EMBODIMENTS

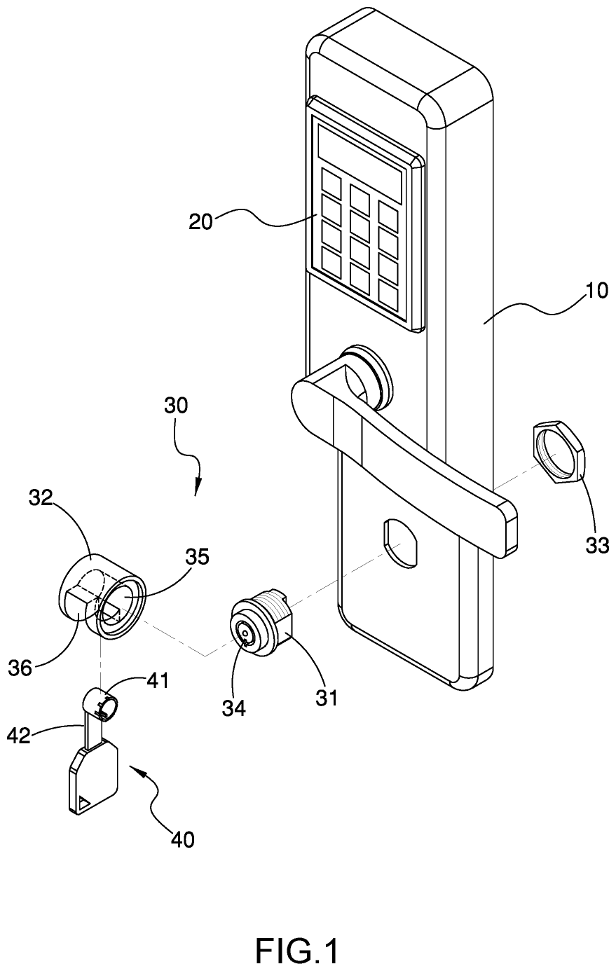

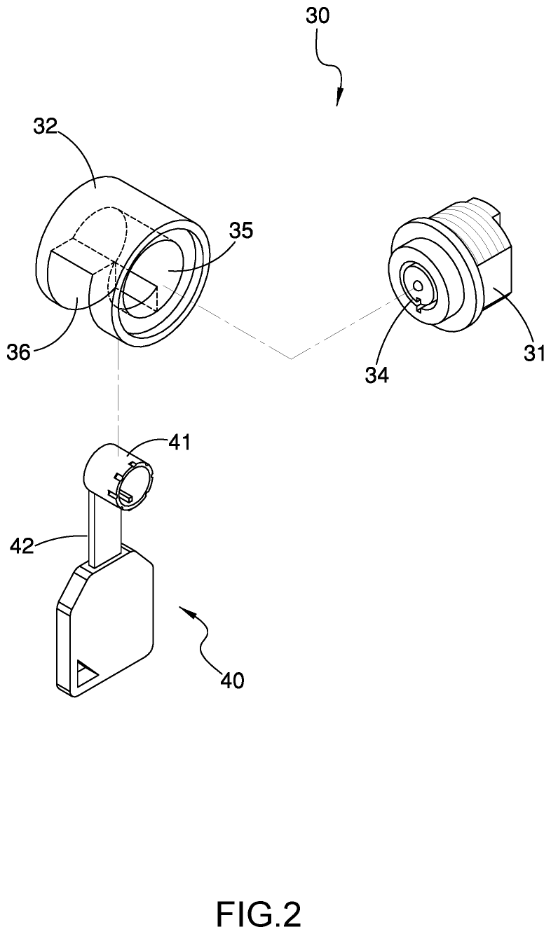

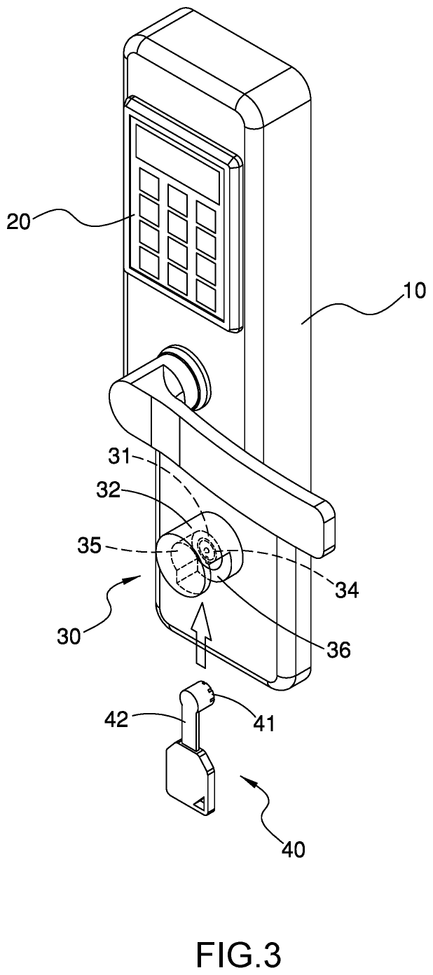

FIGS. 1 to 3 show an anti-theft structure of a dual-locking lock of the invention, which includes a lock body 10, an electronic lock 20, a key lock 30 and a key 40.

The lock body 10 may be mounted on a door panel or other objects to be locked.

The electronic lock 20 is disposed on the lock body 10 and is to be locked and unlocked by a user. The electronic lock 20 includes one or multiple ones of intelligent lock devices, such as a fingerprint identification device, an iris recognition device, a face recognition device, a voice recognition device, a password input device, a sensor input device, and a card input device.

The key lock 30 includes a lock head 31 and a plug cap 32. The lock head 31 is screwed to and combined with the lock body 10 using a nut 33, and a front side surface of the lock head 31 has a key hole 34. The plug cap 32 is barrel-shaped, an inner portion of the plug cap 32 has a chamber 35 with an opening facing a side surface, wherein the opening of the plug cap 32 covers over the front side surface of the lock head 31, and a circumferential surface of the plug cap 32 is provided with a window 36 communicating with the chamber 35.

The key 40 includes a head 41 and an extension arm 42 perpendicularly extending from one side of the head 41, so that the head 41 can be put into the chamber 35 from the window 36 of the plug cap 32 and then inserted into the key hole 34 and then rotated by an angle to perform unlocking or locking.

In the invention, the plug cap 32 may be combined with the lock head 31 or the lock body 10 by way of screwing, embedding, pivotal connecting, welding, integral molding or the like.

In the invention, the lock head 31 is a cylindrical ring lock, and the head 41 of the key 40 is in a form of a barrel capable of mating with the cylindrical ring lock.

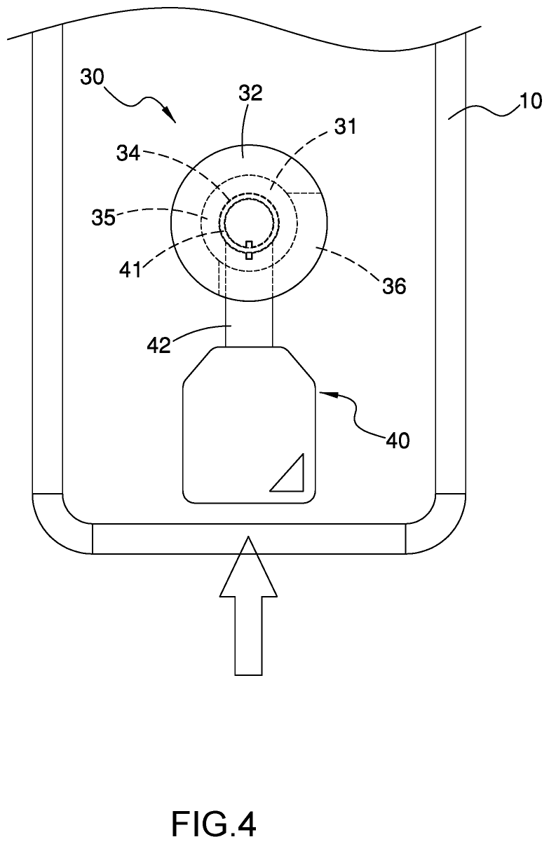

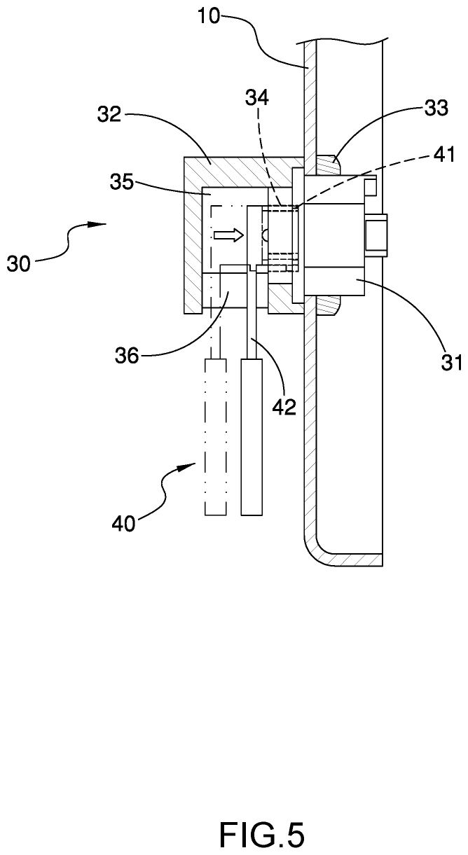

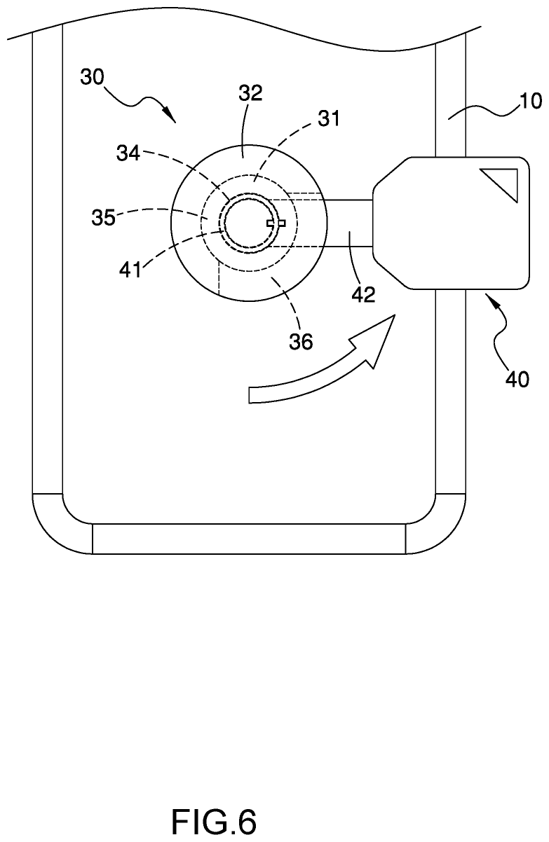

Please refer to FIGS. 4 to 6, when the lock is to be unlocked, the head 41 of the key 40 is firstly put into the chamber 35 from the window 36 in a first direction (e.g., X-axis), and then inserted into the key hole 34 in a second direction perpendicular to the first direction (e.g., Y axis), and finally the extension arm 42 is used to rotate the head 41 counterclockwise by an angle, so that the objective of unlocking can be achieved, or otherwise the objective of locking can be achieved.

In the anti-theft structure of the dual-locking lock provided by the invention, the plug cap 32 can cover over the front side of the lock head 31 to prevent the key hole 34 of the lock head 31 from being directly and obviously exposed to the outside, so that the thief cannot directly see internal structures, such as the lock beads, in the lock head 31 through the key hole 34. Moreover, the window 36 formed on the circumferential surface of the plug cap 32 can be used to unlock and lock the key 40 of the special structure of the invention, and also prevent the common unlocking tools available in the market from being inserted into the key hole 34 for unlocking. Therefore, it has a good anti-theft effect and can avoid the security flaw of the dual-locking lock.

In summary, the invention has the above-mentioned advantages and practical values, and no similar products are published, so that the application requirements of the invention patent have been satisfied, and the application is filed according to the law.

What is claimed is:

1. An anti-theft structure of a dual-locking lock, the anti-theft structure comprising:
a lock body;
an electronic lock, which is disposed on the lock body and is to be locked and unlocked by a user;
a key lock comprising a lock head and a plug cap, wherein the lock head is combined with the lock body, a front side surface of the lock head has a key hole, and an inner portion of the plug cap has a chamber with an opening facing a side surface, wherein the opening of the plug cap covering over the front side surface of the lock head, and a circumferential surface of the plug cap is provided with a window communicating with the chamber; and
a key comprising a head and an extension arm perpendicularly extending from one side of the head, so that the head can be put into the chamber from the window of the plug cap and then inserted into the key hole and then rotated by an angle to perform unlocking or locking.

2. The anti-theft structure according to claim 1, wherein the electronic lock comprises one of a fingerprint identification device, an iris recognition device, a face recognition device, a voice recognition device, a password input device, a sensor input device and a card input device.

3. The anti-theft structure according to claim 1, wherein the electronic lock comprises multiple ones of a fingerprint identification device, an iris recognition device, a face recognition device, a voice recognition device, a password input device, a sensor input device and a card input device.

4. The anti-theft structure according to claim 1, wherein the lock head is screwed to and combined with the lock body using a nut.

5. The anti-theft structure according to claim 1, wherein the plug cap is barrel-shaped.

6. The anti-theft structure according to claim 1, wherein the plug cap is combined with the lock head.

7. The anti-theft structure according to claim 1, wherein the plug cap is combined with the lock body.

8. The anti-theft structure according to claim 1, wherein the lock head is a cylindrical ring lock, the head of the key is in a form of a barrel capable of mating with the cylindrical ring lock.
